(19) United States
(12) Patent Application Publication
(10) Pub. No.: US 2026/0251088 A1
(43) Pub. Date: Aug. 27, 2026

(54) TWO-STROKE INTERNAL COMBUSTION ENGINE HAVING A COMBUSTION CHAMBER WITH A PRE-CHAMBER

(71) Applicant: BRP-ROTAX GMBH & CO. KG, Gunskirchen (AT)

(72) Inventors: Thomas ZORN, Stadl-Paura (AT); Thomas GRUBER, Gangkofen (DE); Roland KIRCHBERGER, Graz (AT); Roland OSWALD, Ehrenhausen (AT); Nigel FOXHALL, Semriach (AT)

(21) Appl. No.: 19/548,189

(22) Filed: Feb. 24, 2026

Related U.S. Application Data
(60) Provisional application No. 63/762,746, filed on Feb. 25, 2025.

(51) Int. Cl. F02B 19/18; F02B 19/12

(52) U.S. Cl. CPC F02B 19/18; F02B 19/12

(57) ABSTRACT

A two-stroke internal combustion engine has: a cylinder; a piston having a piston crown; a combustion chamber roof, the cylinder, the piston, and the combustion chamber roof defining a combustion chamber; an ignition device, the combustion chamber roof having an oval roof outline having a longitudinal axis, the combustion chamber roof having squish surfaces disposed between the roof outline and the cylinder; and a pre-chamber projecting into the combustion chamber in a center of the combustion chamber roof, the pre-chamber being connected to the ignition device, the pre-chamber defining nozzle openings distributed over a circumference of the pre-chamber. A first angular distance between the nozzle openings assigned to outline sections in a region of the longitudinal axis of the roof outline being smaller than a second angular distance between the nozzle openings assigned to intermediate outline sections of the roof outline.

### CROSS-REFERENCE

The present application claims priority to United States Provisional Patent Application No. 63/762,746, filed February 25, 2025, the entirety of which is incorporated herein by reference.

### FIELD OF TECHNOLOGY

The present technology relates to two-stroke internal combustion engines having a combustion chamber with a pre-chamber.

### BACKGROUND

In order to achieve good mixture preparation in the combustion chamber of two-stroke internal combustion engines, as described in European Patent Publication EP 4 293 210 A1, published December 20, 2023, it is known to provide a dome-shaped combustion chamber roof with a plane of symmetry that is aligned with a central plane defined by the cylinder axis and the axis of an exhaust port of the cylinder. Since the outline diameter of the combustion chamber roof is smaller than the diameter of the cylinder, a conical squish surface is formed between the combustion chamber roof and the cylinder, which interacts with the piston crown. During an upward movement of the piston, high compression and turbulence of the fuel-air mixture is achieved at the squish surface near the top dead center, as the fuel-air mixture moves into the combustion chamber roof at high speed. In order to not only provide a comparatively large cross-sectional area, but also to achieve a mixture distribution in the combustion chamber that is favorable for combustion, the dome of the combustion chamber roof is shifted off-center towards the side of the cylinder opposite from the exhaust port. Instead of a spherical dome, however, the combustion chamber roof can also have an oval roof outline, the longitudinal axis of which is aligned perpendicular to the central plane of the cylinder. Despite these measures, however, there is an uneven flame propagation across the combustion chamber after ignition of the fuel-air mixture by a spark plug that is arranged in the central plane but off-center of the combustion chamber roof.

To improve combustion of the fuel-air mixture, as described in International Patent Publication WO 2024/184024 A1, published September 12, 2024, it is also known in internal combustion engines to provide a pre-chamber in the combustion chamber roof of the cylinders which projects into the combustion chamber and is provided with nozzle openings evenly distributed around the circumference of the cylindrical pre-chamber, so that the combustion chamber is connected to the pre-chamber through these nozzle openings. The fuel fed into the combustion chamber and mixed with combustible air is therefore pressed through the nozzle openings into the pre-chamber during the compression stroke of the piston, in order to then be ignited with the aid of a spark plug projecting into the pre-chamber, with the effect that jets of flame evenly distributed around the circumference emerge from the nozzle openings and ignite the fuel-air mixture within the combustion chamber, which leads to a more even ignition of the fuel-air mixture in the combustion chamber. However, this arrangement cannot ensure a uniform propagation of the flame front in the combustion chamber depending on the fuel distribution in the combustion chamber.

There is therefore a desire for a two-stroke internal combustion engine which provides efficient mixture formation and uniform combustion of the fuel-air mixture.

### SUMMARY

It is an object of the present technology to ameliorate at least some of the inconveniences present in the prior art.

The present technology relates to a two-stroke internal combustion engine with at least one cylinder accommodating a piston and provided with an exhaust port, the combustion chamber of which is provided with an ignition device and has a combustion chamber roof with an oval roof outline which extends symmetrically to a central plane defined by the cylinder axis and the axis of the exhaust port, and which interacts with the piston crown between the combustion chamber roof and the cylinder to form squish surfaces.

In a two-stroke internal combustion engine according to the present technology, a longitudinal axis of the oval roof outline extends in the central plane, a pre-chamber projects into the combustion chamber in the center of the combustion chamber roof, wherein the pre-chamber is provided with the ignition device and is closed with the exception of nozzle openings distributed over its circumference. The angular distance between the nozzle openings assigned to the outline sections in the area of the longitudinal axis of the roof outline is smaller than the angular distance between the nozzle openings assigned to the intermediate outline sections, and/or the nozzle openings angularly closest to the longitudinal axis have a larger flow cross-section than the other nozzle openings.

The selected orientation of the longitudinal axis of the oval roof outline results in larger squish surface areas on both sides of the central plane, which cause a squish surface flow directed towards the central plane on both sides and thus a beneficial influence on the formation of the main scavenging jet. In addition, residual gas pockets that would otherwise form on the cylinder wall alongside the main scavenging jet are blown towards the center of the combustion chamber. In order to form corresponding flame fronts, the resulting largely uniform fuel-air mixture in the combustion chamber is ignited with the aid of a pre-chamber enclosing the ignition device, from which, after ignition of the fuel-air mixture in the pre-chamber, flame jets emerge into the combustion chamber through the nozzle openings distributed around its circumference and ensure ignition of the fuel-air mixture in the combustion chamber, forming corresponding flame fronts. However, these conditions are not sufficient for uniform combustion of the fuel-air mixture in the combustion chamber, because during the downward movement of the piston, stronger suction flows are formed in the region of the larger squish surfaces on both sides of the central plane than in the outline sections in the region of the longitudinal axis of the oval roof outline, and therefore the flame fronts in the area of the stronger suction flows would propagate into the combustion chamber faster than in the other areas if a preferential flame propagation in the direction of the longitudinal axis of the oval roof outline is not ensured. For this, the arrangement and design of the nozzle openings around the circumference of the pre-chamber are selected such that the nozzle openings assigned to the outline sections in the area of the longitudinal axis of the roof outline, i.e., its narrow sides, cause a greater density of the flame jets, so that the flame fronts spread faster in the area of these narrow sides than in the other circumferential sections and thus create a balance that takes into account the different suction flows. For this purpose, the nozzle openings can have a different angular distance from each other and/or be designed with different flow cross-sections. As a result of these measures, the engine performance can be increased because an even propagation of the flame fronts in the combustion chamber helps prevent knocking.

Due to the suction flows resulting from the squish surfaces during the downward stroke of the piston in the top dead center region, the nozzle openings are aligned in the direction of the outline edge of the combustion chamber roof, therefore the axes of the nozzle openings are angled in relation to the cylinder axis.

Due to the spatial limitation of the cylindrical pre-chamber, the number of nozzle openings is also limited, the flow cross-sections of which are within a diameter range that is limited both downwards and upwards according to the flow conditions to be taken into account. In order to take this circumstance into account, in some embodiments, six nozzle openings are provided, diametrically opposed in pairs, one pair of which is located in the central plane, while the other nozzle openings are arranged symmetrically to the central plane.

According to one object, the techniques described herein relate to a two-stroke internal combustion engine including: a cylinder defining an exhaust port and having a cylinder axis; a piston disposed in the cylinder, the piston having a piston crown; a combustion chamber roof connected to the cylinder, the cylinder, the piston, and the combustion chamber roof defining a combustion chamber; an ignition device disposed at least in part in the combustion chamber, the combustion chamber roof having an oval roof outline extending symmetrically with respect to a central plane, the central plane being defined by the cylinder axis and a central axis of the exhaust port, a longitudinal axis of the oval roof outline extending in the central plane, the combustion chamber roof having squish surfaces disposed between the oval roof outline and the cylinder, the squish surfaces being configured to cooperate with the piston crown; and a pre-chamber projecting into the combustion chamber in a center of the combustion chamber roof, the pre-chamber being connected to the ignition device, the pre-chamber defining nozzle openings distributed over a circumference of the pre-chamber, and a first angular distance between the nozzle openings assigned to outline sections in a region of the longitudinal axis of the oval roof outline being smaller than a second angular distance between the nozzle openings assigned to intermediate outline sections of the oval roof outline.

In some aspects, the techniques described herein relate to a two-stroke internal combustion engine, wherein first nozzle openings of the nozzle openings have a larger flow cross-section than second nozzle openings of the nozzle openings, the second nozzle openings being angularly further from the central plane than the first nozzle openings.

In some aspects, the techniques described herein relate to a two-stroke internal combustion engine, wherein the nozzle openings are angled with respect to the cylinder axis such that the nozzle openings extend away from the ignition device as the nozzle openings extend away from the cylinder axis.

In some aspects, the techniques described herein relate to a two-stroke internal combustion engine, wherein the nozzle openings generally face an edge of the oval roof outline.

In some aspects, the techniques described herein relate to a two-stroke internal combustion engine, wherein: the nozzle openings include six nozzle openings; the six nozzle openings are disposed diametrically opposite one another in pairs; one of the pairs lies in the central plane; and another two of the pairs are arranged symmetrically to the central plane.

According to another object, the techniques described herein relate to a two-stroke internal combustion engine including: a cylinder defining an exhaust port and having a cylinder axis; a piston disposed in the cylinder, the piston having a piston crown; a combustion chamber roof connected to the cylinder, the cylinder, the piston, and the combustion chamber roof defining a combustion chamber; an ignition device disposed at least in part in the combustion chamber, the combustion chamber roof having an oval roof outline extending symmetrically with respect to a central plane, the central plane being defined by the cylinder axis and a central axis of the exhaust port, a longitudinal axis of the oval roof outline extending in the central plane, the combustion chamber roof having squish surfaces disposed between the oval roof outline and the cylinder, the squish surfaces being configured to cooperate with the piston crown; and a pre-chamber projecting into the combustion chamber in a center of the combustion chamber roof, the pre-chamber being connected to the ignition device, the pre-chamber defining nozzle openings distributed over a circumference of the pre-chamber, and first nozzle openings of the nozzle openings have a larger flow cross-section than second nozzle openings of the nozzle openings, the second nozzle openings being angularly further from the central plane than the first nozzle openings.

In some aspects, the techniques described herein relate to a two-stroke internal combustion engine, wherein a first angular distance between the nozzle openings assigned to outline sections in a region of the longitudinal axis of the oval roof outline being smaller than a second angular distance between the nozzle openings assigned to intermediate outline sections of the oval roof outline.

In some aspects, the techniques described herein relate to a two-stroke internal combustion engine, wherein the nozzle openings are angled with respect to the cylinder axis such that the nozzle openings extend away from the ignition device as the nozzle openings extend away from the cylinder axis.

In some aspects, the techniques described herein relate to a two-stroke internal combustion engine, wherein the nozzle openings generally face an edge of the oval roof outline.

In some aspects, the techniques described herein relate to a two-stroke internal combustion engine, wherein: the nozzle openings include six nozzle openings; the six nozzle openings are disposed diametrically opposite one another in pairs; one of the pairs lies in the central plane; and another two of the pairs are arranged symmetrically to the central plane.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

### BRIEF DESCRIPTION OF THE FIGURES

For a better understanding of the present technology, as well as other aspects and further features thereof, reference is made to the following description which is to be used in conjunction with the accompanying drawings, where:

FIG. 1 shows a two-stroke internal combustion engine according to the present technology in a schematic axial section along the central plane defined by the cylinder axis and the axis of the exhaust port, with the piston position in a bottom dead center position;

FIG. 2 is a section taken along line II-II of FIG. 1;

FIG. 3 is a section of the cylinder in an area of the combustion chamber roof with the piston in the top dead center position, in a schematic cross-section corresponding to FIG. 1 on a larger scale; and

FIG. 4 is a section taken along line IV-IV of FIG. 3.

### DETAILED DESCRIPTION

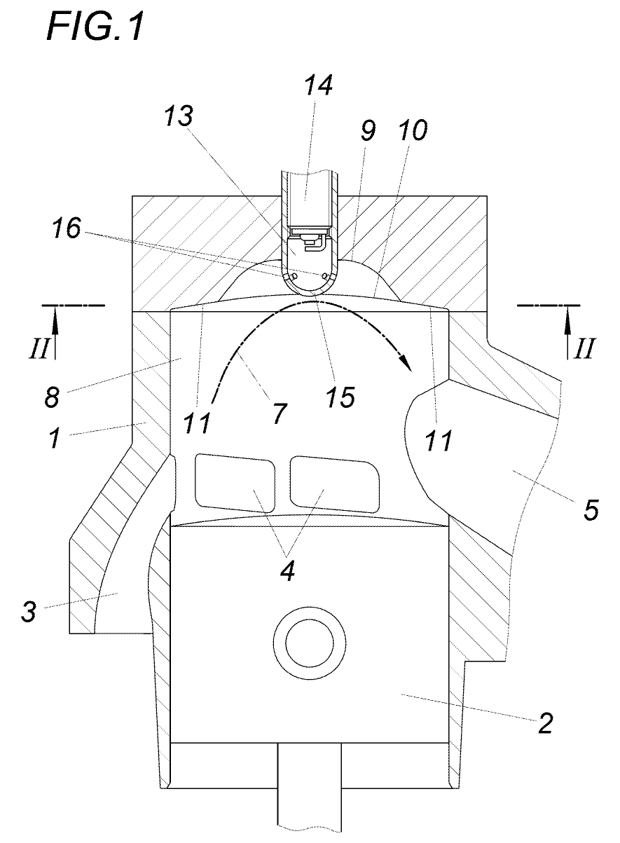

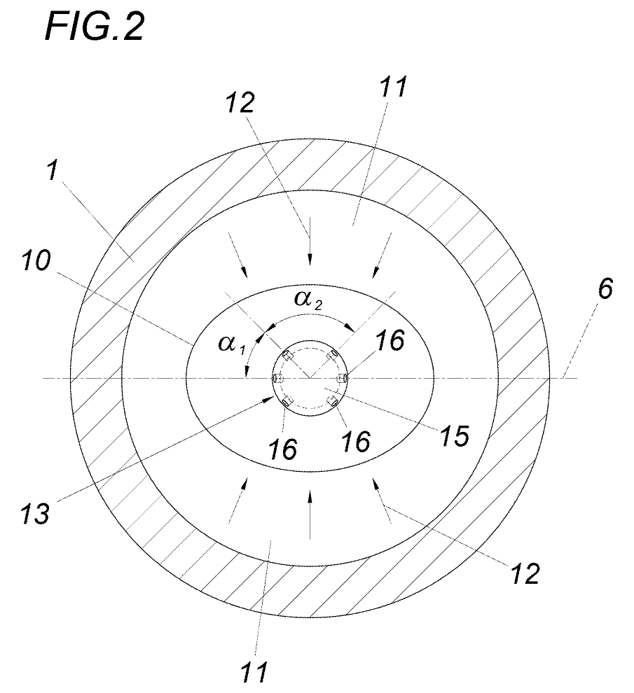

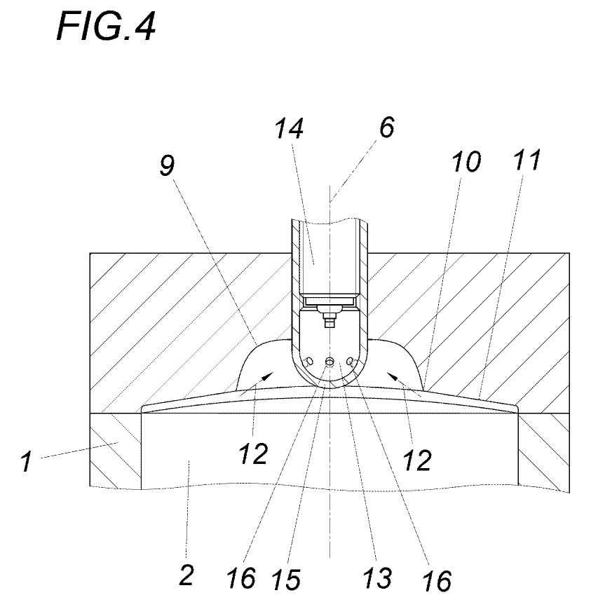

With reference to FIG. 1, a two-stroke internal combustion engine according to the present technology has at least one cylinder 1 and a piston 2 disposed in the cylinder 1. The piston 2 controls opening and closing the transfer ports 3, 4 between the crankcase and the cylinder 1. The piston 2 has a piston crown. In the central plane 6 of the cylinder 1, which is defined by the cylinder axis and a central axis of the exhaust port 5 and indicated by a dotted line in FIGS. 2 and 4, the transfer port 3 is provided on the side of the cylinder axis opposite the exhaust port 5, while the other transfer ports 4 are located symmetrically opposite the central plane 6. This arrangement results in a main scavenging flow 7, schematically indicated in FIG. 1, from transfer port 3 to exhaust port 5.

A trough-shaped combustion chamber roof 9 with an oval roof outline 10 is connected to the cylinder 1. The cylinder 1, the piston 2, and the combustion chamber roof 9 define a combustion chamber 8. As can be seen from FIG. 2, this roof outline 10 extends symmetrically to the central plane 6, with the longitudinal axis of the roof outline 10 lying in the central plane 6. Between the roof outline 10 and the cylinder 1 there are squish surfaces 11 which, due to the ovality of the roof outline 10, are wider in the direction of the transverse axis of the roof outline 10 perpendicular to the central plane 6 than in the direction of the longitudinal axis. The squish surfaces 11 are configured to cooperate with the piston crown. This means that during the upward movement of the piston 2 near the top dead center, an increasing squish surface flow, indicated by flow arrows 12 in FIGS. 2 and 4, occurs due to the narrowing squish gap between the piston crown and the squish surfaces 11, which runs transversely to the central plane 6 and allows additional mixing of the fuel-air mixture and thus creates conditions for efficient combustion, which can be provided if a uniform combustion of the fuel in the combustion chamber 8 is achieved and thus an even spread of the flame front is ensured.

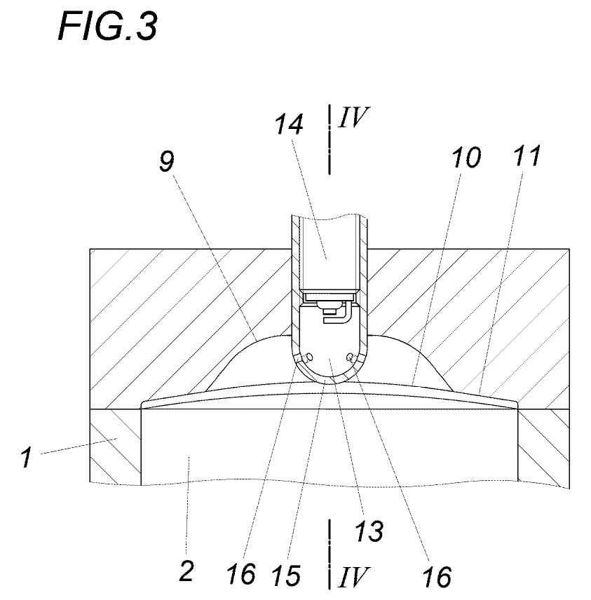

The design specifications provided for this purpose include a pre-chamber 13 provided centrally in the combustion chamber roof 9 and projecting into the combustion chamber 8, into which an ignition device 14, for example a spark plug, is partially disposed. The pre-chamber 13 is connected to the ignition device 14. As can be seen in FIGS. 2 to 4, the pre-chamber 13, which forms an end cap 15, is provided with nozzle openings 16 formed in the end cap 15 and distributed around its circumference. In some embodiments, the nozzle openings 16 are angled with respect to the cylinder axis such that the nozzle openings 16 extend away from the ignition device 14 as the nozzle openings 16 extend away from the cylinder axis. In the present embodiment, the nozzle openings generally face an edge of the roof outline 10. The fuel-air mixture introduced into the pre-chamber 13 through the nozzle openings 16 during charging of the cylinder 1 is ignited in the pre-chamber with the aid of the ignition device 14. As a result of this ignition, jets of flame emerge through the nozzle openings 16 into the combustion chamber 8 and ignite the fuel, spreading a flame front corresponding to the circumferential distribution of the nozzle openings 16.

As best seen in FIG. 2, the nozzle openings 16 are not distributed evenly around the circumference of the cylindrical pre-chamber 13. Between the nozzle openings 16, which are aligned towards the narrow sides of the oval roof outline 10, i.e. towards outline sections in the region of the longitudinal axis of the roof outline 10, there is a smaller angular distance α1 than the angular distance α2 between the nozzle openings 16 aligned towards the intermediate outline sections of the roof outline 10. In the present embodiments, there are six nozzle openings 16 that are disposed diametrically opposite one another in pairs. One of the pairs lies in the central plane 6. The other two pairs are arranged symmetrically about the central plane 6. The nozzle openings 16 located between the nozzle openings 16 in the central plane 6 are assigned to both the narrow sides and the wide sides of the roof outline 10, which results in the angular distances α1 and α2 as shown in FIG. 2. It is contemplated that more or less than six nozzle openings 16 could be provided. In one embodiment, the angle α1 is 45 degrees and the angle α2 is 90 degrees.

During the downward movement of piston 2, starting from the top dead center position, the squish surface flow 12 is reversed into a suction flow. As the combustion chamber 8 opens into the cylinder 1, a larger proportion of the fuel-air mixture is drawn from the transfer ports 3, 4 into the combustion chamber 8 in the area of the larger suction flow, i.e., in the area of the longitudinal side of the roof outline 10, which would lead to an uneven flame propagation in the cylinder 1 if the flame fronts were to spread evenly within the roof area. To prevent this, the flame jets from the nozzle openings 16 of the pre-chamber 13 are directed at a greater density towards the narrow sides of the roof outline 10, so that a balance is achieved that accounts for the different suction flows.

The desired distribution density of the flame jets can also be influenced by different flow cross-sections of the nozzle openings 16, so that the number and orientation of the nozzle openings 16 and their flow cross-sections make it possible to account for the different flow conditions resulting from the different widths of the squish surfaces 11. In one embodiment, the nozzle openings 16 aligned with the longitudinal axis have a larger flow cross-section than the other nozzle openings 16 that are angularly further from the central plane 6.

Modifications and improvements to the above-described embodiments of the present technology may become apparent to those skilled in the art. The foregoing description is intended to be exemplary rather than limiting. The scope of the present technology is therefore intended to be limited solely by the scope of the appended claims.

What is claimed is:

1. A two-stroke internal combustion engine comprising:
a cylinder defining an exhaust port and having a cylinder axis;
a piston disposed in the cylinder, the piston having a piston crown;
a combustion chamber roof connected to the cylinder,
the cylinder, the piston, and the combustion chamber roof defining a combustion chamber;
an ignition device disposed at least in part in the combustion chamber,
the combustion chamber roof having an oval roof outline extending symmetrically with respect to a central plane,
the central plane being defined by the cylinder axis and a central axis of the exhaust port,
a longitudinal axis of the oval roof outline extending in the central plane,
the combustion chamber roof having squish surfaces disposed between the oval roof outline and the cylinder,
the squish surfaces being configured to cooperate with the piston crown; and
a pre-chamber projecting into the combustion chamber in a center of the combustion chamber roof,
the pre-chamber being connected to the ignition device,
the pre-chamber defining nozzle openings distributed over a circumference of the pre-chamber, and
a first angular distance between the nozzle openings assigned to outline sections in a region of the longitudinal axis of the oval roof outline being smaller than a second angular distance between the nozzle openings assigned to intermediate outline sections of the oval roof outline.

2. The two-stroke internal combustion engine according to claim 1, wherein first nozzle openings of the nozzle openings have a larger flow cross-section than second nozzle openings of the nozzle openings, the second nozzle openings being angularly further from the central plane than the first nozzle openings.

3. The two-stroke internal combustion engine according to claim 1, wherein the nozzle openings are angled with respect to the cylinder axis such that the nozzle openings extend away from the ignition device as the nozzle openings extend away from the cylinder axis.

4. The two-stroke internal combustion engine according to claim 3, wherein the nozzle openings generally face an edge of the oval roof outline.

5. The two-stroke internal combustion engine according to claim 1, wherein:
the nozzle openings include six nozzle openings;
the six nozzle openings are disposed diametrically opposite one another in pairs;
one of the pairs lies in the central plane; and
another two of the pairs are arranged symmetrically about the central plane.

6. A two-stroke internal combustion engine comprising:
a cylinder defining an exhaust port and having a cylinder axis;
a piston disposed in the cylinder, the piston having a piston crown;
a combustion chamber roof connected to the cylinder,
the cylinder, the piston, and the combustion chamber roof defining a combustion chamber;
an ignition device disposed at least in part in the combustion chamber,
the combustion chamber roof having an oval roof outline extending symmetrically with respect to a central plane,
the central plane being defined by the cylinder axis and a central axis of the exhaust port,
a longitudinal axis of the oval roof outline extending in the central plane,
the combustion chamber roof having squish surfaces disposed between the oval roof outline and the cylinder,
the squish surfaces being configured to cooperate with the piston crown; and
a pre-chamber projecting into the combustion chamber in a center of the combustion chamber roof,
the pre-chamber being connected to the ignition device,
the pre-chamber defining nozzle openings distributed over a circumference of the pre-chamber, and
first nozzle openings of the nozzle openings have a larger flow cross-section than second nozzle openings of the nozzle openings, the second nozzle openings being angularly further from the central plane than the first nozzle openings.

7. The two-stroke internal combustion engine according to claim 6, wherein a first angular distance between the nozzle openings assigned to outline sections in a region of the longitudinal axis of the oval roof outline being smaller than a second angular distance between the nozzle openings assigned to intermediate outline sections of the oval roof outline.

8. The two-stroke internal combustion engine according to claim 6, wherein the nozzle openings are angled with respect to the cylinder axis such that the nozzle openings extend away from the ignition device as the nozzle openings extend away from the cylinder axis.

9. The two-stroke internal combustion engine according to claim 8, wherein the nozzle openings generally face an edge of the oval roof outline.

10. The two-stroke internal combustion engine according to claim 6, wherein:
the nozzle openings include six nozzle openings;
the six nozzle openings are disposed diametrically opposite one another in pairs;
one of the pairs lies in the central plane; and
another two of the pairs are arranged symmetrically about the central plane.
